(19) United States
(12) Patent Application Publication
(10) Pub. No.: US 2025/0209383 A1
(43) Pub. Date: Jun. 26, 2025

(54) SYSTEMS AND METHODS FOR FEDERATED LEARNING

(71) Applicant: Meta Platforms, Inc., Menlo Park, CA (US)

(72) Inventors: Luhui Hu, Bellevue, WA (US); Yinglong Xia, San Jose, CA (US)

(21) Appl. No.: 17/016,107

(22) Filed: Sep. 9, 2020

(51) Int. Cl. G06N 20/20; G06F 16/901; G06N 5/02; G06N 5/04

(52) U.S. Cl. CPC G06N 20/20; G06F 16/9024; G06N 5/02; G06N 5/04

(57) ABSTRACT

In one embodiment, one or more computing systems may generate a knowledge graph representing relationships between a global model and a number of local models for updating the global model. Each local model may have access to a local dataset for machine-learning training. The systems may access, from the knowledge graph, a sharing policy associated with the local dataset of a first local model. The systems may determine, based on the knowledge graph and one or more pre-determined criteria, that the sharing policy permits the local dataset of the first local model to be shared with a second local model. The system may cause the second local model to be trained using at least the local dataset of the first local model and the local dataset of the second local model. The system may update the global model using the trained second local model.

### TECHNICAL FIELD

This disclosure generally relates to training of machine-learning models, in particular, to federated learning.

### BACKGROUND

A social-networking system, which may include a social-networking website or a mobile application, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more network content, or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

Particular embodiments described herein relate to systems and methods of using one or more knowledge graphs to track and enforce data sharing conditions for federated learning. The system may generate a global knowledge graph (and one or more federated knowledge graphs) that includes a number of graph nodes and a number of edges connecting these graph nodes. Each graph node in the knowledge graph may represent a federated node (i.e., local site) or a central server. Each graph node may be associated with a node profile describing the represented federated node (e.g., including information related to associated ML (machine learning) models, policies, parameters, parameter groups, etc.). Each edge connecting two graph nodes may represent a relationship (e.g., connections and interactions) between the two represented federated nodes. Each edge may be associated with data sharing conditions (e.g., privacy policies) describing the represented relationship. For example, an edge connecting a first graph node and a second graph node may be associated with a privacy policy which may indicate that a first federated node (represented by the first graph node) and a second federated node (represented by the second graph node) may share a first type of data set (e.g., a public data type) but may not share a second type of data set (e.g., a private data type). A graph node in a knowledge graph may correspond to or represent a sub-graph and the knowledge graph may include many layers along the hierarchy. For example, a graph node representing a local site (e.g., a first university) may have its own child sites (e.g., other universities or entities managed by the first university) which may be represented by a corresponding sub-graph. The knowledge graph system may be hosted on a central server or/and a number of local sites that are connected to the central server (e.g., the same server or local sites for performing federated learning or different servers or local sites that are associated with federated learning). For global policies that apply to the central server and all local sites, the global knowledge graph may capture that information and apply that information globally. For local polices between local sites, the knowledge graph (e.g., global or federated) may capture that information in the corresponding edges connecting the graph nodes representing these sites. When an operation (e.g., distributing ML (machine learning) models, sharing/fetching data, sending back training results) is planned by the central server or a local site of the federated learning system, the operation may be registered in the knowledge graph system which may check the operation against the corresponding data sharing policy captured in the knowledge graph. When the operation complies with the corresponding policy, the knowledge graph system may allow that operation to be performed. When the operation does not comply with the corresponding policy, the knowledge graph system may send instructions to the central server or the local site of the federated learning system to prevent that operation to be performed. As a result, the knowledge graph system may provide an effective solution for tracking and enforcing the data sharing policies for the federated learning process.

Furthermore, the knowledge graph system may use graph learning or machine-learning to determine one or more inferences to coordinate and optimize the federated learning process. For example, two local sites represented by two graph nodes in the knowledge graph may have a particular type of data that is similar and can be combined to generate better training samples. The knowledge graph system may use the knowledge graph to determine that these two nodes cannot share that particular type of data with the server, but these two nodes can share this data with each other. The knowledge graph system may send instructions to these two local sites to cause the data to be shared between these two local sites. As a result, the ML (machine learning) models may be trained more effectively due to the combined data. As another example, the knowledge graph system may use graph learning to figure out a data-sharing path between a first node and a second node that have no direct relationship. The knowledge graph system may generate a new edge connecting the corresponding graph nodes in the knowledge graph and may send instructions to the corresponding local sites to cause these two sites to share data during the federated learning process. As another example, the knowledge graph system may use the global knowledge to determine that particular ML models (e.g., with particular features and parameters) should be distributed to particular locate sites because these sites have the data needed to train these ML models with those particular features and parameters. As another example, the knowledge graph system may use graph learning to determine that a data sharing path has implied restrictions set by policies that are not associated with any edges along the data sharing path. For instance, the knowledge graph system may determine that Node A can share any data with Node B and with the central server. However, Node B has a restricting policy preventing a particular data set C to be shared with the central server. The knowledge graph system may determine that the potential data sharing path of B-A-server does not apply to that particular data set C. When the data set C is shared from the Node B to Node A, the restricting policy associated with the data set C should be carried over to the Node A so that the data set C cannot be shared with the server. As another example, the knowledge graph system may use the knowledge graph and graph learning to figure out the lineage of a data set used in training ML models. The system may determine the data integrity and data consistency based on the data lineage. As another example, the system may use the graph learning or machine-learning to identify the best set of node models, parameters, and parameters groups for the final training of the global model. Each local node may continuous refine/train its local model. The latest iteration of the local model might not always be the best one. The system use the inference results of the graph-learning to allow the final global model to find and adopt the best local models (rather than simply adopting the latest version of the local models). As a result, the knowledge graph system may provide an effective solution for generating inferences based on the knowledge graph and use these inferences to coordinate and optimize the federated learning process in real-time.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example federated learning system.

FIG. 2 illustrates an example framework for using a knowledge graph system to coordinate and optimize federated learning.

FIG. 3 illustrates an example knowledge graph including a global knowledge graph and a sub-graph.

FIG. 4A illustrates an example process for using a knowledge graph to enforce data sharing policies between federated nodes.

FIG. 4B illustrates an example process using a knowledge graph to identify new relationships between federated nodes based on inferences from the knowledge graph.

FIG. 4C illustrates an example process for using knowledge graph to identify implied data sharing restrictions.

FIG. 5 illustrates an example method of using a knowledge graph to optimize federated learning.

FIG. 6 illustrates an example network environment associated with a social-networking system

FIG. 7 illustrates example social graph.

FIG. 8 illustrates an example computer system.

### DESCRIPTION OF EXAMPLE EMBODIMENTS

Federated learning or collaborative learning may allow a central server to distribute ML models to a number of local sites (i.e., federated nodes) for training these ML models based on respective local data samples on these local sites. The distributed ML models may be separately trained on respective local sites based on corresponding local data. The trained models and some parameters may be sent back to the central server to be aggregated into the global model. As a result, federated learning may allow ML models to be trained without transmitting the site data to other sites or the central server, thereby protect data privacy. However, traditional federated learning lacks mechanisms to track and enforce data sharing policies and could be less-optimal for training ML models in many respects. For example, some sites may have similar data which, if combined, would make training more effective. However, because traditional federated learning lacks mechanisms to track data sharing policies, traditional federated learning may not able to cause data to be shared between these sites even if sharing of this data is permitted by corresponding policies.

Particular embodiments of the system may use knowledge graph(s) to track and enforce data sharing conditions for federated learning. When an operation (e.g., distributing ML models, sharing/fetching data, sending back training results) of the federated learning process is scheduled by the central server or a local site, the operation may be registered in the knowledge graph system which may check the operation against the corresponding data sharing policy captured in the knowledge graph. When the operation complies with the corresponding policy, the knowledge graph system may allow that operation to be performed. When the operation does not comply with the corresponding policy, the knowledge graph system may send instructions to the central server or the local site of the federated learning system to prevent that operation from being performed. Furthermore, the system may use the knowledge graph(s) to generate inferences based on existing knowledge, and coordinate and optimize the federated learning process based on these inferences. As a result, the knowledge graph system may provide an effective solution for tracking and enforcing the data sharing policies to coordinate and optimize federated learning.

By using a knowledge graph, particular embodiments of the system may provide an effective solution for tracking and enforcing the data sharing conditions for federated learning. By tracking and enforcing the data sharing conditions of federated learning, particular embodiments of the system may allow the data privacy of each local site to be better protected during the federated learning process. By generating inferences based on the knowledge graph and using these inferences to coordinate the federated learning process, particular embodiments of the system may provide an effective solution to optimize federated learning to allow the ML models to be better trained. By selecting and aggregating the local models that are in the best modes for training results, particular embodiments of the system may allow the global model to incorporate high-quality training results and achieve better overall training results. By tracking and managing information (e.g., node profiles, polices, models, parameters, parameter groups) using knowledge graph(s), particular embodiments of the system may track and manage the knowledge related to the federated nodes and models at a global perspective and generate inferences that could be used to improve and optimize the federated learning process (e.g., of next iteration) and allow the federated learning process to be accumulative and iterative.

Federated learning (also referred to as collaborative learning) may be a machine learning technique that can train an algorithm (e.g., ML models) across multiple decentralized computing systems (e.g., servers, edge devices, computers at different local sites) holding local data samples, without exchanging their data samples between each other. This approach may stand in contrast to traditional centralized machine learning techniques where all data samples are uploaded to one server, as well as to classical decentralized approaches which assume that local data samples are identically distributed. Federated learning may enable multiple actors (e.g., a central server and a number of federated nodes (i.e., local sites)) to build a common and robust machine learning model without sharing data between these actors, thus address critical issues such as data privacy, data security, data access rights and access to heterogeneous data. To ensure good task performance of a final, central machine learning model, federated learning may rely on an iterative process which includes an atomic set of client-server interactions known as a federated learning round. Each round of this process may include transmitting the current global model to participating local sites, training local models on these local sites to produce a set of potential model updates at each locate site, and aggregating and processing these local updates into a single global update and applying it to the global model.

In this disclosure, a federated node or a local site may refer to an entity (e.g., a university, a data center, an agency, etc.) having one or more local computing systems that are used during the federated learning process. The term “federated node” and “locate site” may be used in an interexchange way. The local computing systems may receive models that need to be trained from the central server and train these models locally based on local data samples that the local computing systems have access to. The federated learning system may include a number of federated nodes which may be connected to a central server through communication networks and may receive the ML models from the central server. In this disclosure, a global model may refer to a ML model or a statistical model that is or will be trained. The global model may be hosted on a central server and may be distributed to one or more federated nodes (i.e., local sites) with initial parameters or current parameters. After the model is transmitted or distributed to these local sites, these models may be referred to as local models (hosted on respective local sites). These local models may be trained on respective local sites based on local data samples of these local sites. The global model may update its parameters based on the aggregation results from a number of local models that are trained on respective local sites. In particular embodiments, a graph node may refer to a vertex in the knowledge graph which may correspond to an entity having a central server, a local computing system, or a sub-graph corresponding to a sub-network of computing systems. In particular embodiments, a federated learning system may refer to, collectively, the central server and the local computing systems at different local sites and any other systems that are used for federated learning.

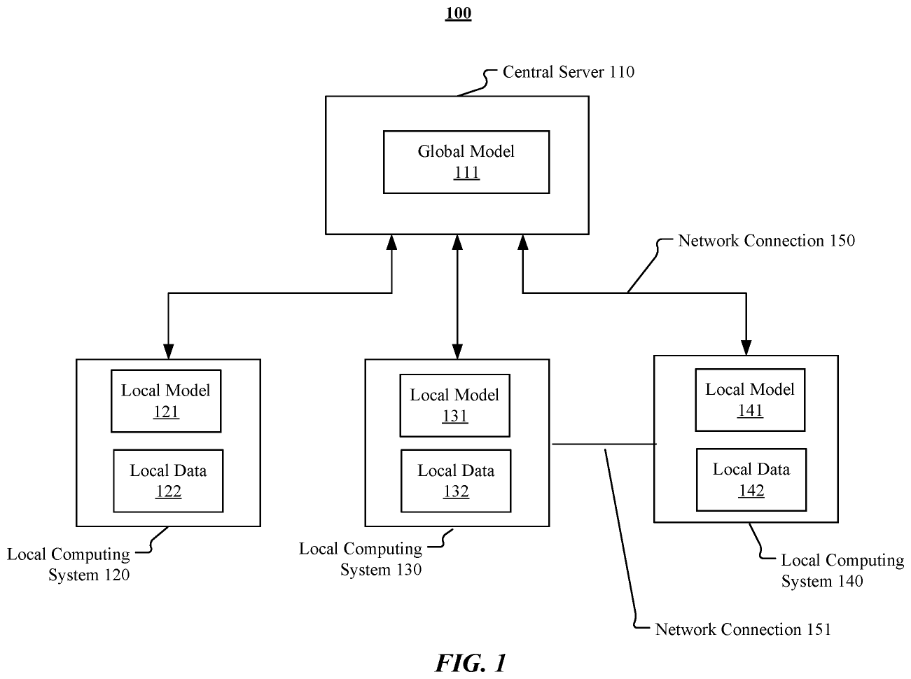

FIG. 1 illustrates an example federated learning system 100. As an example and not by way of limitation, the federated learning system 100 may include a central server 110 and a number of local computing systems (e.g., 120, 130, and 140). Each local computing system (e.g., 120, 130, and 140) may be connected to the server 110 through network connections 150. Some local computing systems (e.g., 131 and 141) may also be connected to each other through corresponding network connections (e.g., 151). In this example, the global model 111 (e.g., a ML model or a statistical model) may be hosted on the central server 110. During the federated learning process, the central server 110 may identify a ML model or a statistical model that needs to be trained and may transmit that model in current state to a number of local computing systems (e.g., 120, 130, and 140) during a model synchronization process. The model in current state may be a model having initial parameters before training or may be a model with current parameters that have been partially trained during the last training iteration. After receiving the model from the central server 110, each local computing system (e.g., 120, 130, and 140) may access the its local data samples (e.g., 122, 132, and 142) and train the corresponding local model (e.g., 121, 131, and 141) locally based on the accessed local data samples. As a result, different local models (e.g., 121, 131, and 141) may have different parameter values after being trained on the corresponding local computing systems using the local data samples of that local computing system. After that, the local computing systems (e.g., 120, 130, and 140) may transmit the respective local models (e.g., 121, 131, and 141) with the trained parameters (or transmit these trained parameters) to the central server 110. The central server 110 may aggregate the training results from these local computing systems and integrate the trained parameters to the global model 111. As a result, the global model 111 may be trained without the central server 110 accessing the local data samples (e.g., 122, 132, and 142) on these local computing systems (e.g., 120, 130, and 140).

In particular embodiments, federated learning may be used to train ML models or statistic models while protecting data security and data privacy and reducing data transfer over the network (e.g., avoiding transmitting a large volume of training data of deep learning). Unlike traditional distributed learning, federated learning may enable training on heterogeneous datasets without exposing the data from its hosting computing systems. Federated learning may include a number of steps, for example, distributing models to local sites, training respective local models on corresponding local sites, transmitting training results from local sites to the central server, and aggregating the training results of different models to the global model. However, there could be a number of challenges to effectively train a model with the limited information on data sharing among the local sites (i.e., federated nodes). Furthermore, in traditional federated learning, the central server may aggregate the training results from a number of local sites and then generate one global mode without accessing any data from these local sites. However, the information in the training results could be limited compared to the traditional machine learning, which can completely train the model based on the whole dataset.

In non-federated learning, all datasets may be taken as a whole and may be accessed by all computing systems used for training. The features and training data may be pre-processed and trained across different computing systems that are used for training. For example, a first computing system has dataset A and dataset B, a second computing system has dataset C and dataset D. In the traditional non-federated learning, the computing systems may generate a better feature dataset based on dataset A and dataset C if they are more relative to each other. But in federated learning, the data may not be shared among the computing systems used for training. As a result, the training results may be compromised. For example, as shown in FIG. 1, the local computing system 120 and the local computing system 130, although each being connected to the central server 110, may not be aware of each other's existence and consequently may not able to share data with each other. However, in some scenarios, a local model may be better trained based on a combination of the local data samples 122 and 132 (e.g., the local samples 122 and 132 may be the same type of data samples being complementary to each other). Since the federated learning system may not able to cause the data samples 122 and 132 to be shared by their hosting computing systems 120 and 130, the overall training results may be less optimal than what the data samples can possibly facilitate.

In federated learning, data privacy and security may be important factors why federated learning is adopted (instead of the traditional learning). Data privacy may be categorized into two types of privacy: global privacy and local privacy. However, it could be challenging for the federated learning system to track the lineage and provenance of data to address global privacy and local privacy properly. Federated learning may employ interactive learning process for improving the global model. However, it could be challenging for the federated learning system to manage the interactions with all these local computing systems. For example, a first local computing system may train three models of A1, B1, and C1, in sequence. A second local computing system may train three models of A2, B2, and C2 in sequence. An effective global model should be generated with the combination of best trained models or the combination of latest models, which is not necessary the same to the latest models being trained. However, without knowing the overall context, it will be hard for the central server to determine if the latest models are the best trained models among all these trained models. Furthermore, the inference results from federated nodes could be useful to optimize the global model training. But in traditional federated learning, it would be challenging to apply these inference results in real-time to the global training by considering privacy because of lacking mechanisms to track all privacy policies and generate inferences based on existing policies at the system level.

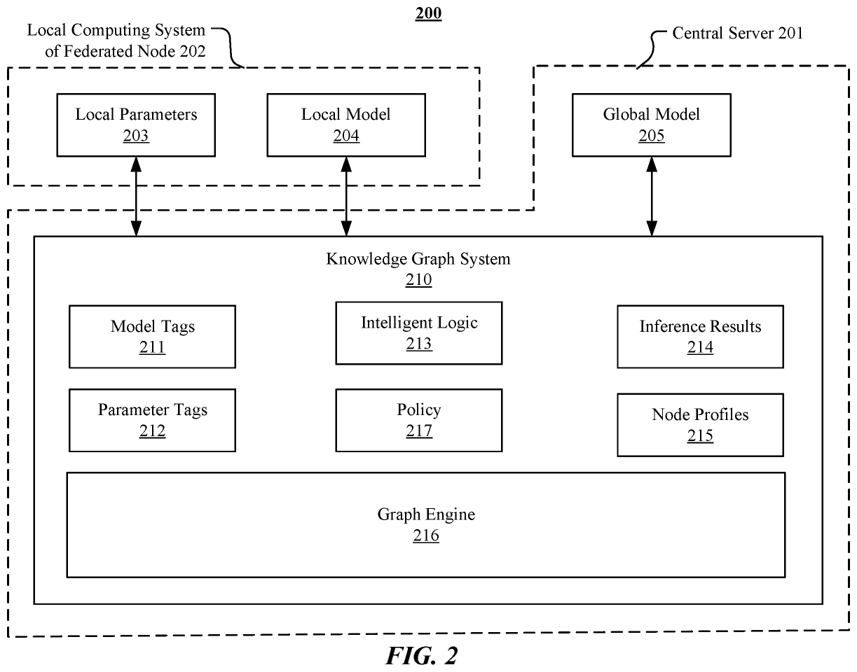

FIG. 2 illustrates an example framework 200 for using a knowledge graph system 210 to coordinate and optimize federated learning. In particular embodiments, the knowledge graph system 210 may include a number of modules or sub-systems including, for example, but not limited to, a model tag module 211, a parameter tag module 212, an intelligent logic module 213, an inference results module 214, a node profile module 215, a policy module 217, a graph engine 216, etc. In particular embodiments, the knowledge graph system 210 may fetch or receive information related to the central server 201 and local computing systems (e.g., 203) of the federate nodes (including local models (e.g., 204)) that directly communicate with the central server 201 to generate a global knowledge graph. In particular embodiments, the knowledge graph system 210 may receive information from the local computing systems at the local sites using APIs or other interface modules through computer storages, data buses, or communication networks. In particular embodiments, the knowledge graph system 210 may receive information about the central server 201 and the local computing system 202 of a federated node from direct or indirect user inputs characterizing the server, the federated nodes, and the relationships. The information about the central server 201 and local computing system 202 of the federated node that is received by the knowledge graph system 210 may include, for example, but are not limited to, local models and related parameters on local computing system 202 of the federated node, the global model and related parameters on the central server 201, a node profile of the central server, a node profile of each federated node, privacy policies of the central server, privacy policies of each federated node, data sharing policies of the federated nodes, data sharing policies of particular datasets, data type information for the data samples on the federate nodes, etc.

In particular embodiments, the knowledge graph system 210 may generate knowledge graphs based on the fetched or received information related to the central server 201 and the local computing systems (e.g., 202) at corresponding federated nodes. For example, the knowledge graph system 210 may send the fetched or received information to the graph engine 216 and use the graph engine 216 to generate, store, and manage the knowledge graphs. The knowledge graph system 210 may generate one or more model tags for each local model and the global model and may store these model tags in the model tag module 211. The knowledge graph system 210 may generate one or more parameter tags for each parameter of the local models and the global model and may store the parameters tags in the parameter tag module 212. The knowledge graph system 210 may use the model tags stored in the model tag module 211 to access the corresponding models in the knowledge graph stored in the graph engine 216. The knowledge graph system 210 may use the parameter tags stored in the parameter tag module 212 to access the corresponding parameters in the knowledge graph stored in the graph engine 216. The knowledge graph system 210 may store accessing information (e.g., index, tags, names, etc.) of the privacy policies and data sharing polices in the policy module 217. The knowledge graph system 210 may store the accessing information (e.g., index, tags, names, etc.) of the node profiles in the node profile module 215. The accessing information may be used to access or retrieve the corresponding policies or profiles from the knowledge graph stored in the knowledge graph engine 216.

In particular embodiments, the knowledge graph system 210 may use the intelligent logic module 213 to learn new knowledge through graph learning based on existing knowledge in the knowledge graph or newly received knowledge from user inputs. In particular embodiments, the intelligent logic 213 may include one or more rule-based algorithms, statistic algorithms, ML models (e.g., convolutional neural networks (CNNs), graph neural networks (GNN)), etc. The intelligent logic module 213 may identify new relationships and discover hidden relationships between the entities as represented by corresponding graph nodes in the knowledge graph based on inferences determined through graph learning. The knowledge graph system 210 may store these inference results in the inference result module 214. The new knowledge (e.g., new relationships determined based on the inference results) as learned by the intelligent logic module 213 may be feedback to the graph engine 216 to update the knowledge graph (e.g., generating new edges representing the new relationships or interactions between graph node representing corresponding entities, assigning inferred policies to particular graph nodes or edges, etc.).

In particular embodiments, the knowledge graph system 210 may be hosted on, for example, the central server 201 which may also host or store the global model 205 that is trained during the federated learning process. In particular embodiments, a number of knowledge graph systems (e.g., 210) may be hosted on one or more local computing systems of different federated nodes or a combination of one or more local computing systems of federated nodes and the central server 201. For example, the central server 201 may host a knowledge graph system 210 which may generate and manage a global knowledge graph. The global knowledge graph may be used to coordinate the server 201 and the federated nodes that directly connected to the server 201. At the same time, a local computing system (e.g., 202) of a federated node may host another knowledge graph system (not shown) which may generate a federated knowledge graph to coordinate that federated node and other sub-level federated nodes in its sub-network (e.g., network of networks). Here, the federated node may serve as one of many federated nodes to the central server 201 but at the same time may serve as a sub-level central server to its sub-level federated nodes. As a result, the federated learning system may have multiple knowledge graph systems at different sub-network levels and may be coordinated using knowledge graphs at different hierarchy levels. In particular embodiments, a knowledge graph system 210 may be installed on the central server and each federated node of the federated learning system. During federated learning, the federated learning system may use a global knowledge graph to coordinate and optimize the federated learning process at a global level and may use one or more federated knowledge graphs to coordinate and optimize the federated learning processes at different sub-network levels.

In particular embodiments, a federated knowledge graph corresponding to a sub-network may be represented as a graph node in the global knowledge graph. The central server 201 may only directly coordinate the federated nodes that are represented by graph nodes in the global knowledge graph, for example, the first level federated nodes that directly communicate with the central server 201. A federated node having sub-level federated nodes in its sub-network may coordinate these sub-level federated nodes using its own federated knowledge graph for that sub-network. It is notable that the global knowledge graph living on or being hosted by the central server may describe a logic concept for a cloud architecture. The global knowledge graph may be physically stored on another computing system or device associated with the central server instead of being physically stored on the central server itself. Similarly, a federated knowledge graph living on or being hosted by a federated node may describe a logic concept for a cloud architecture. The federated knowledge graph may be physical stored on another computing system or device associated with that federated node.

In particular embodiments, a knowledge graph may include a knowledge data structure representing interactions and relationships (e.g., as represented by edges) between individual entities (e.g., federated nodes as represented by graph nodes). As an example and not by way of limitation, a knowledge graph may include a number of graph nodes and a number of edges connecting these nodes. In this disclosure, the term “graph node” may refer to a vertex point in the knowledge graph being at end of one or more edges. In particular embodiments, each graph node in the knowledge graph may represent a federated node (i.e., local site) or a central server. Each graph node may be associated with a node profile describing the represented federated node (e.g., including information related to associated ML models, parameters, etc.). Each edge connecting two graph nodes may represent a relationship (e.g., connections and interactions) between the two federated nodes as represented by these two graph nodes. Each edge may be associated with data sharing conditions (e.g., privacy policies, data sharing policies) describing the represented relationship. For example, an edge connecting a first graph node and a second graph node may be associated with a privacy policy which may indicate that a first federated node (represented by the first graph node) and a second federated node (represented by the second graph node) may share a first dataset (e.g., a public data type) but may not share a second dataset (e.g., a private data type). In particular embodiments, a graph node in the knowledge graph may represent or correspond to a sub-graph (e.g., a federated knowledge graph corresponding to a sub-network) and the knowledge graph may have many layers along the hierarchy. For example, a graph node representing a federated node (e.g., a first university) may have its own child nodes (e.g., other universities or entities managed by the first university) which may be represented by corresponding sub-level federated nodes.

In particular embodiments, the graph nodes in the knowledge graph may represent a model (e.g., a ML model or statistic model that is being or will be trained by the federated learning system). Specifically, the local models of the federated nodes, the global model, the models' parameters and the parameter groups (PGs) may all be represented by different types of graph nodes in the knowledge graph. In particular embodiments, the parameter groups (PGs) may be a set of relevant parameters for organizing the parameters. A single parameter may belong to multiple parameter groups (PGs). A graph node in the global knowledge graph may have an embedded sub-graph for a corresponding sub-network (e.g., network of networks). The graph node in the knowledge graph may be connected based on the relationships between the represented models or parameter groups. For example, the parameters or parameter groups from a federated node (i.e., a local site) may be connected with a model hosted on the federated node (i.e., local site). In particular embodiments, these relationships may be weighted by or bound with inference results and node profiles. The global model corresponding to the final model of federated learning may serve at the federated nodes which could be or include, for example, mobile applications. In particular embodiments, the inference results and values may be different or even significantly different from a federated node to another federated node. Node profiles may contain statistical information for helping federated learning and graph learning excluding any sensitive information.

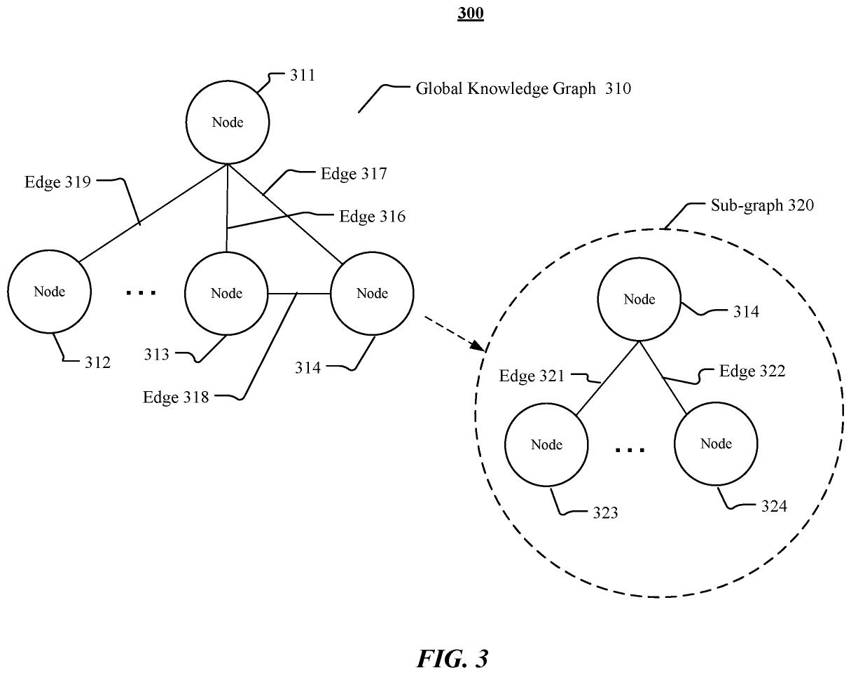

FIG. 3 illustrates an example knowledge graph 300 including a global knowledge graph 310 and a sub-graph 320. As an example and not by way of limitation, the global knowledge graph 310 may include a root graph node 311 representing a central server of the federated learning system or the model hosted on the central server. The graph nodes 312, 313, and 314 may represent the corresponding federated nodes (i.e., local sites) or the models hosted on these federated nodes. The federated nodes as represented by the graph nodes 312, 313, and 314 may be the first level nodes that communicate (e.g., receiving local models, uploading trained parameter values, etc.) with the central server (as represented by the root graph node 311) through network connections. These relationships for sharing models and parameters through the network connections may be presented by the edges (e.g., 316, 317, 318, and 319) in the global knowledge graph 310. Some of the federated nodes (e.g., corresponding to the graph nodes 313 and 314) may directly communicate with each other for sharing models, data samples, parameters, policy information, etc. This relationship may be represented by the edges (e.g., 318) that directly correct the corresponding graph nodes (e.g., 313 and 314).

In particular embodiments, a federated node may have its own sub-level nodes within its sub-network. The central server may be connected to these sub-level nodes through the intermediate federated nodes that are directed connected to the central server and the sub-level federated nodes. The central server may use a global knowledge graph to track and manage the immediate child nodes and delegate the intermediate nodes to track their sub-level nodes using respective federated knowledge graphs. As an example and not by way of limitation, as shown in FIG. 3, the federated node as represented by the graph node 314 may have sub-level federated nodes within its own sub-network. The federated learning system may allow the federated node as represented by the graph node 314 to host a separate knowledge graph system with respect to the knowledge graph system hosted on the central server. The knowledge graph system hosted on the federated node having sub-level nodes may generate a federated knowledge graph which is a sub-graph 320 of the global knowledge graph. In the sub-graph 320, the federated node as represented by the graph node 314 may serve as the sub-level server in this sub-network. The graph nodes 323 and 324 may represent the sub-level nodes in this sub-network. The edges 321 and 322 may represent the relationships between the sub-level server and sub-level nodes within this sub-network. In the global knowledge graph 310, this sub-network may be represented by a single graph node 314. The central server hosting the global knowledge graph may or may not be aware the sub-level nodes within the sub-network. Instead, the central server hosting the global knowledge graph may allow the federated node as represented by the graph node 314 to manage its own sub-level nodes through the sub-network 320. In this way, the knowledge graph as a whole may include a number of layers of sub-graphs along a hierarchy.

In particular embodiments, the graph nodes in the knowledge graph may represent entities corresponding to the central server or federated nodes used for federated learning or may represent the models and parameters groups hosted by the server or local computing systems of these entities. The edges in the knowledge graph may represent the relationship and interaction between the nodes connected by these edges. In particular embodiments, the edges may be associated with the privacy policies or data sharing policies governing the represented relationships and interactions. For example, an edge may be associated with a data sharing policy which allows a public type of data to be shared between the two entities corresponding to the two graph nodes connected by that edge and prohibit any other types of data to be shared between these two entities. In particular embodiments, the graph nodes representing federated nodes may be associated with respective node profiles describing the models, parameters, parameter groups, and types of data samples, sharing policies of different dataset of the data samples, etc., on the represented federate nodes. The knowledge graph system(s) may fetch the information associated with the node profiles and generate or update the knowledge graph by: generating new nodes for newly added entities, generating new edges to represent new relationships determined based on existing relationships or new relationship information, assigning data sharing policies (which could be determined based on fetched information or based on inference from existing policies) to corresponding edges, removing redundant policy assignments, generating sub-graph for sub-networks, etc.

In particular embodiments, the federated learning process may be integrated with the graph learning process using the knowledge graph(s). During the federated learning process, the central server may initiate the global model and then, distribute the initiated model to a number of federated nodes in the federated learning system. Once the model is distributed to a federated node, it may be referred to as a local model of the federated node. Each federated node that is a direct child node of the central server may register their information (e.g., node profile, models, parameters, etc.) in the global knowledge graph. The central server may configure and update a global knowledge graph to include the information about the global model and the local models on each federated node. Each federated node having a local model may train that model based on the local data samples on that federated node. After being trained locally at respective federated nodes, the local models and/or the model parameters may be transmitted from these federated nodes back to the central server. The information related to the models and parameters that are transmitted back to the central server may be registered in the global knowledge graph. The central server may update the corresponding node profiles in the global knowledge graph, add parameter information, and add the local model information to the global knowledge graph. After being trained, the local models and corresponding parameters may be transmitted back to the centralized server. The central server may aggregate all these distributed local models that have been trained on respective federated nodes and generate the final training model. The final model may be updated based on be an aggregation of a number of local models that are trained on respective federated nodes. The above process may correspond to an iteration of the federated learning process based on the knowledge graph system.

In traditional federated learning process, the initialized global model may be distributed to federated nodes to be trained locally on these federated nodes. This federated learning process may be repeated many times, and the distributed models may always be the global model in the initial state. In contrast, particular embodiments the federated learning system as described in this disclosure may allow the federated learning process to be accumulative and iterative. During each iteration, the federated system may distribute the current version of the global model (e.g., initial global model or the global model that has been trained during the last iteration) to the federated nodes for training. The federated nodes may train respective local nodes based on the corresponding local data on these federated nodes starting from the current state of the model and the iterative training process may be repeated until the global model meets the training criteria. In particular embodiments, after an iteration of the federated learning process has completed, the central server may run the graph learning based on the current global knowledge graph to generate new inferences (e.g., new data sharing paths, redundant data sharing paths, data types on federate nodes, data type-model match information, best sets of local modes, new policies, new sharing restrictions, new relationships, implied relationships, etc.). The inferences may be based on a combination of the newly received and update information (e.g., new node profiles, new polices, etc.) and previously existing information in the global knowledge graph. The federated learning system may use these inferences to optimize the federated learning process during the next iteration (e.g., by causing data to be shared along the new data sharing paths, by matching local models to federated nodes having particular data types, by combining data samples of federated nodes having similar data types, etc.). The federated learning system may continuously or periodically generate and apply inferences to optimize the training process in real-time during the federated learning process. Each iteration of the federated learning process may be further optimized and improved with respect to the former iteration and, as a result, the global model may achieve better training results by using this iterative and accumulative federated learning process. Similarly, the intermediate nodes with sub-level nodes may host their own knowledge graph systems and use corresponding federated knowledge graphs to improve and optimize each iteration of the federated learning process following the same or similar principle as described above.

In particular embodiments, the federated learning system may use the knowledge graph to track and manage a number of global policies and a number of local policies for particular federated nodes. The global policies may be applicable to the models hosted on the central server and all federated nodes. The federated learning system may capture information related to the global policies in the knowledge graph and globally apply them to all entities that are represented in the knowledge graphs. The local polices may be associated with particular federated nodes. The knowledge graph may capture information related to these local polices in the corresponding edges connecting the graph nodes representing these federated nodes. In particular embodiments, the global polices may be set by the knowledge graph system users at the global level to protect data privacy in general. The local polices of each federated node may be set according to the data privacy and sharing policies of each local entity and the entities within its sub-network. For example, personal information should be protected at all levels of the federated learning system by global policies and entity-related information of each entity should be protected according the local policies of that entity. The central server may not have access to the entity-specific information of the entities corresponding to the federated nodes.

In particular embodiments, when an operation (e.g., distributing ML models, sharing/fetching data, sending back training results) related to a federated learning process is scheduled by the federated learning system (e.g., by the central server or one or more federated nodes), the operation may be firstly registered in the knowledge graph system before being performed. The federated learning system may use the knowledge graph to check the operation against the corresponding data sharing policies. When the operation complies with the corresponding policies, the federated learning system may allow that operation to be performed. When the operation does not comply with one or more corresponding policies, the federated learning system may send instructions to the computing system requesting that operation to prevent that operation from being performed. As a result, the knowledge graph system may provide an effective solution for tracking and enforcing the data sharing policies for the federated learning process.

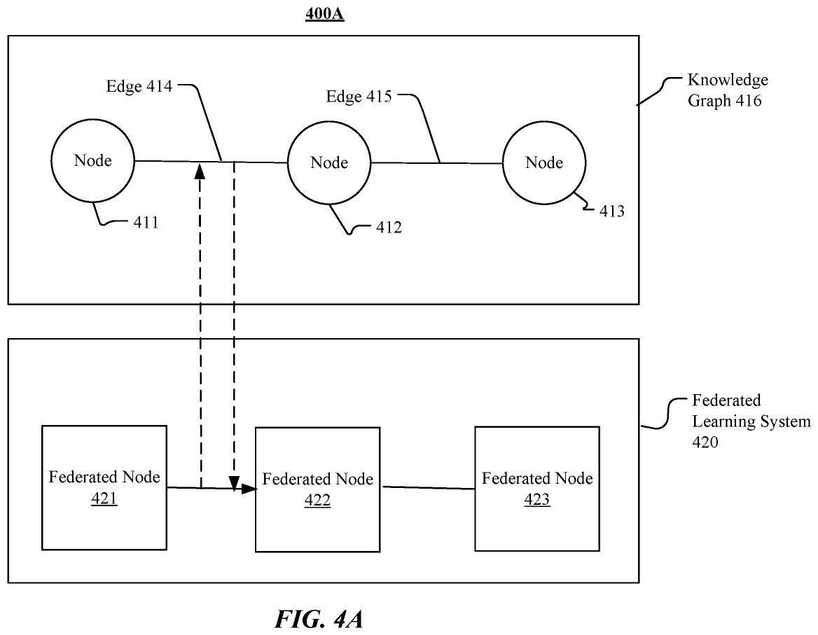

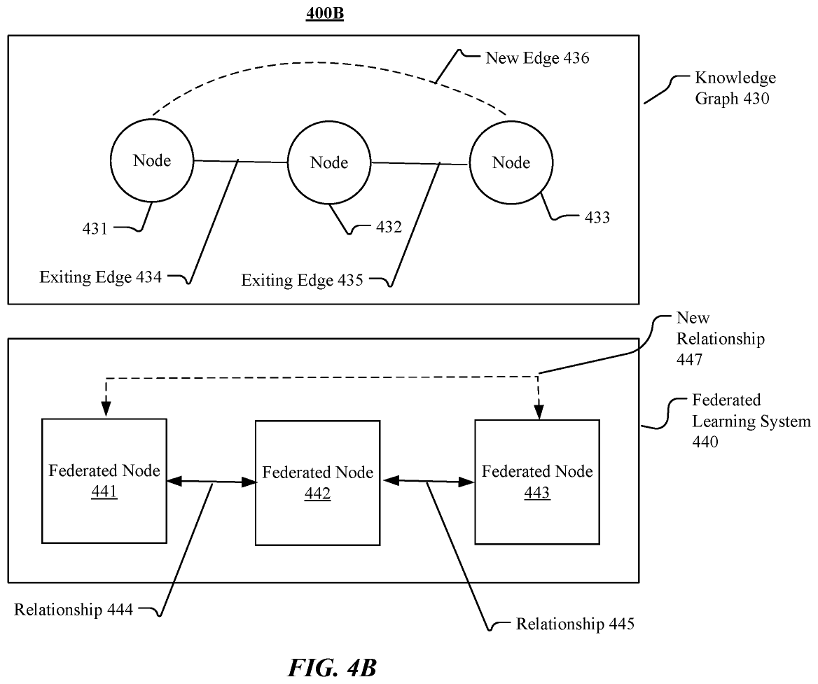

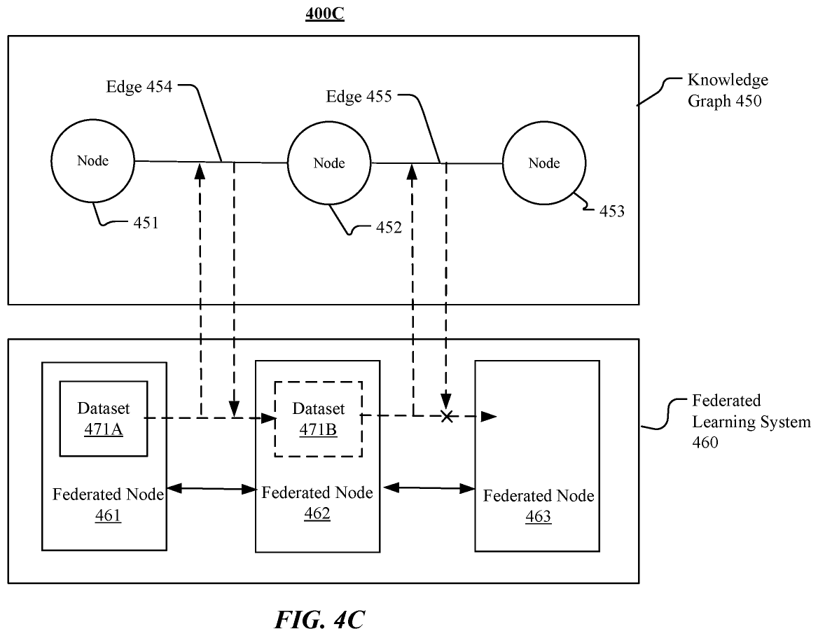

FIG. 4A illustrates an example process 400A for using a knowledge graph to enforce data sharing policies between federated nodes. In particular embodiments, the local polices of a federated node may be associated to one or more edges connecting that federated node to other nodes or to the central server. The local policies may be applicable to a subset of datasets on the federated node or may be applicable to all datasets on that federated node. The local policies may allow particular datasets to be shared with other federated nodes while prohibiting other datasets from being shared. Before data is transmitted from a federated node to another, the data transmission operation may be registered in the global knowledge graph or corresponding federated knowledge graph and may be checked against the corresponding policies. As an example and not by way of limitation, the graph nodes 411, 412, and 413 in the knowledge graph 416 may correspond to the federated nodes 421, 422, and 423, respectively, in the federated learning system 420. When the local models are trained locally on the federated nodes 421 and 422 based on respective local data, the federated node 421 may have some datasets that would be helpful to the federated node 422 for training its local model. The federated learning system 420 may learn this information from the inferences based on the previously training results or the node profiles for 421 and 422, etc. The federated learning system 420 may send this information to the federated nodes 421 and 422 which may plan a data transmission operation to transmit that dataset to and from the federated node 421 to 422. Before this data transmission operation being executed, the federated learning system 420 may register this operation to the knowledge graph 416 and check this operation against the corresponding data sharing polices associated with edge 414 which represents the relationship and interaction between the federated nodes 421 and 422. The federated learning system 420 may determine that: (1) whether the polices (e.g., originated from the federated node 421) permit the federated node 421 to transmit the dataset to the federated node 422, and (2) whether the policies (e.g., originated from the federated node 422) permit the federated node 422 to receive the dataset from the federated node 421. The policies originated from the federated nodes 421 and 422 may be both assigned to the edge 414 representing the relationship between them. The edge 415 may connect the nodes 412 and 413.

In response to the corresponding policies permitting the dataset to be transmitted by 421 and to be received 422, the federated learning system 420 may send instructions to the federated nodes 421 and 422 to cause that dataset to be transmitted from the federated node 421 to the federated node 422. As a result, the federated node 422 may have its local model trained based on both the dataset received from the federated node 421 and the local data samples of the federated node 422 and allow the local model on the federated node 422 to achieve better training results. In response to the corresponding policies do not permit the federated node 421 to transmit the dataset or do not permit the federated node 422 to receive the dataset, the federated learning system may send intervening instructions to the federated nodes 421 and 422 to prevent the dataset from being transmitted from the federated node 421 to the federated node 422. As a result, the data sharing policies may be enforced with the data privacy well protected. In particular embodiments, the federated learning system may use the knowledge graph to enforce the data sharing polices between different federated nodes or between the federated nodes and the central server. In particular embodiments, the system may allow the local data information to be accessed by the global model according to corresponding sharing polices. In particular embodiments, the system may allow the global data information to be accessed by local models hosted on different federated nodes according to corresponding sharing polices. In particular embodiments, the system may allow the global model to use all local models. The knowledge graphs used for enforcing the polices may be a global knowledge graph for the overall federated learning system 420 or a federated knowledge graph for a sub-network of the federated learning system 420. In particular embodiments, by capturing the knowledge (e.g., node profiles, policies, models, parameters, etc.) of the federated learning system at a global level, different nodes of the federated systems may develop and maintain relationships and interaction instead of being isolated from each other. Using the knowledge graph, the federated learning system may allow data to be shared between federated nodes (or the central server) when the policies permit (to better train the models) or prevent data from being shared when the policies prohibit (to enforce the data privacy).

In particular embodiments, because of data privacy, federated learning may be designed in a way that may not allow the local data at the federated nodes to be shared with server or other federated nodes. As a result, training of each local model may have to rely on the local data samples of the respective federated nodes. Even the policies of some federated nodes may allow them to share data with some other federated nodes, the federated learning system may not be able to do so because lack of global knowledge on which federated node can share data with which federated nodes and which datasets are permitted to share and which are not. The federated learning system may have a large number of nodes and may have difficult to track and manage the data sharing without an effective tracking and managing mechanism. If the federated learning system selectively use a sub-set of nodes for training, the final global model may be less optimal because the data on the non-selected node might be important. If the federated learning system try to use the data on each and every node, the training process may be time-consuming and expensive.

In particular embodiments, the federated learning system may use the global knowledge graph to track and manage the over knowledge of all nodes at a global level (and sub-network levels) and use the knowledge graph to coordinate and optimize the federated learning process. The federated learning system may use the graph learning to generate inferred knowledge based on existing knowledge and may classify federated nodes into different categories or types. For example, the system may classify the federated nodes based on node profiles, data types, data sharing polices, directed connected nodes, sub-networks, etc. The system may identify new relationships or implied relationships between different nodes based on the inferences determined from the knowledge graph. In particular embodiments, the federated learning system may use graph learning algorithms to predict that some collections may not be accurate and may be noisy or may introduce inconsistency to the model. The federated learning system may use graph learning to understand the training process to generate a better model and identify the effectiveness of models used in the federated nodes, besides using the graph for data sharing according to corresponding policy. In particular embodiments, the federated learning system may use graph learning to generate inferences related to models, parameters, and other data from a global perspective (e.g., by the central server) and to predict information for final training and updated training. In particular embodiments, the federated learning system may use graph learning to generate inference values and predictions that can be used to adjust the model training in the next iteration. In particular embodiments, the federated learning system may generate some inferences based on the global knowledge graph or based on federated knowledge graphs of respective sub-networks. The generated reference values may be for the central server or an intermediate federated node having sub-level federated nodes. In particular embodiments, the system may use graph learning to predict missing links between two federated nodes if the row of knowledge graph is noisy. In particular embodiments, the system may send inference results to different federated nodes at different locations to cause the corresponding federated nodes to interact with each other based on the inference results.

FIG. 4B illustrates an example process 400B using a knowledge graph to identify new relationships between federated nodes based on inferences from the knowledge graph. As an example and not by way of limitation, the graph nodes of 431, 432, and 433 in the knowledge graph 430 may correspond to the federated nodes 441, 442, and 443, respectively, in the federated learning system 440. The graph node 431 may be connected to the graph node 432 by the edge 434 representing a relationship (e.g., bi-directional data sharing governed by corresponding policies) between the federated nodes 441 and 442. The graph nodes 432 and 433 may be connected by the edge 435 representing a relationship (e.g., bi-directional data sharing governed by corresponding policies) between the federated nodes of 442 and 443. However, the graph nodes 431 and 433 may not be directly connected by any edge in the knowledge graph. Because of lacking direct connection information, during the federated learning process, the federated nodes 441 and 443 may not able to share data with each other even though data sharing may be permitted by the policies along the data sharing path through the federated node 442. The federated learning system may use the knowledge graph to determine that a new relationship or an implied relationship 447 between the federated nodes 441 and 443 based on their existing relationships with respect to the federated node 442. The federated learning system may update the knowledge graph 430 by adding a new edge connecting the graph nodes 431 and 433. The federated learning system may determine the data sharing polices between the two federated nodes 441 and 443 based on the existing data sharing polices associated with the edges 434 and 435. Then, the system may assign the newly determined policies to the new edge 436. During the federated learning process, the system may send instructions to the federated nodes 441 and 443 to cause them to share data with each other (e.g., bi-directional or unidirectional) to achieve better training results for respective local models.

FIG. 4C illustrates an example process 400C for using a knowledge graph to identify implied data sharing restrictions. As an example and not by way of limitation, the graph nodes of 451, 452, and 453 in the knowledge graph 450 may correspond to the federated nodes 461, 462, and 463, respectively, in the federated learning system 460. The graph node 451 may be connected to the graph node 452 by the edge 454 representing a relationship (e.g., bi-directional data sharing governed by corresponding policies) between the federated nodes 461 and 462. The graph nodes 452 and 453 may be connected by the edge 455 representing a relationship (e.g., bi-directional data sharing governed by corresponding policies) between the federated nodes 462 and 463. The dataset 471A on the federated node 461 may be associated with a sharing policy that limits the dataset 471A to be shared only with the federated node 462 and but not any other federated nodes. This policy may be assigned to the edge 454 connecting the graph nodes 451 and 452. The federated nodes 462 and 463 may have a data sharing policy that allows these two federated nodes to share any data with each other. This policy may be assigned to the edge 455 connecting the graph nodes 452 and 453. During the federated learning process, the dataset 471A may be transmitted from the federated node 461 to the federated node 462 to be used for training the local model on the federated node 462. The system may register this data transmission operation to the knowledge graph 450 and check it against the policies assigned to the edge 454. The system may determine that the corresponding policy permits the dataset 471A to be shared with the federated node 462 and may allow the dataset 471A to be transmitted to the federated node 462.

However, a second data transmission operation may try to share the dataset 471B, which is a copy of the dataset 471A, to the federated node 463. If the system only check this data transmission operation against the policies between the federated nodes 462 and 463, which allows them to share any data with each other, the system would allow this data transmission operation to be performed. However, doing so would violate the data policy associated with the dataset 471A that limits the dataset 471A can only be shared with the federated node 462 and no other nodes. In particular embodiments, when the dataset 471A is transmitted to the federated node 462, the system may generate a new policy prohibiting the dataset 471B, which is the copy of the dataset 471A, from being shared with any other nodes except the node 461 where it was originated. This new policy for the dataset 471B may be assigned to the node 452 and any edge (e.g., 455) that connects the node 452 to other nodes (except the edge 454). When any data transmission operation is registered with the knowledge graph 450, the system may not only check this data transmission operation against the polices between the federated nodes 462 and 463 but also against the policy associated with the dataset 471B which is also assigned to the edge 455. Because the knowledge graph provides an overall perspective at a global level, the system may track, manage, and enforce all policies to ensure the data security and data privacy. In this example, the system may determine that, even though the federated nodes 462 and 463 have a policy permitting them to share any data, the dataset 471B cannot be shared between them because of the restriction carried over from the policy associated with dataset 471A. The system may send instructions to the federated node 462 to prevent the dataset 471B from being shared with the federated node 463.

In particular embodiments, when the central server or a federated node needs or fetches a dataset, the system may need to determine the authentication and authorization of the dataset using an authentication and authorization process. In particular embodiments, the system may determine and update lineage information for a dataset whenever the dataset is transmitted from one node to another node. The system may use the knowledge graph to track and manage the lineage of the data that is transmitted between different nodes of the federated learning system. The system may determine the authentication and authorization of the dataset based on the associated lineage information to make sure the data can be trusted. For example, the system may determine a data integrity metric and a data consistency metric based on the lineage information associated with the dataset. The system may determine the original source of the dataset and all the intermediate nodes along the data sharing path by which the dataset is transmitted to the current node. The system may determine a propagation history for each dataset that has been shared between nodes based on the associated lineage information. Furthermore, the system may determine and update one or more new policies associated with a dataset being propagated cross different nodes based on the polices associated with the original source node and all nodes along the propagation path. These policies associated with the dataset may incorporate all restrictions that are applicable to that dataset. By tracking and managing the policies of the dataset based on the lineage, the system may effectively enforce all necessary policies while allowing permitted data sharing to improve the federated training process.

In particular embodiments, the intelligent logic in the graph knowledge system may enable graph learning to identify an effective set of nodes, models and parameters or parameter groups for global training. The effective set of nodes, models, and parameter groups may allow the models to be better trained while reducing unnecessary interactions. The system may use the graph learning to determine the similarity between federated nodes (e.g., according to their local structures, model parameters). The similarity may be used as the learned weight for the federated learning process. The set of graph nodes with higher similarity may suggest a stronger cohesiveness and may form an effective node set. As an example and not by way of limitation, the knowledge graph system may use the global knowledge to determine that particular ML models (e.g., with particular features and parameters) should be distributed to particular federated nodes because these sites have the data needed to train these ML models with those particular features and parameters.

In particular embodiments, the knowledge graph system may extract one or more model attributes capturing information related to the models and training process. The model attributes may capture information related training efficiency or other model metrics including, for example, but not limited to, precision (e.g., average precision score (APS)), recall, receiver operating characteristic (ROC), area under the curve (AUC), logic loss function (LLF), etc. The system may identify the effective set of nodes, models, and parameters (or parameter groups) based on the attribute information captured in the knowledge graph. In particular embodiments, the knowledge graph system may provide graph algorithms such as graph clustering, random walk, etc., to explore and coordinate the entities to optimize the federated learning process. In particular embodiments, the federated learning system may use graph learning to figure different paths from one node to another node. The system may determine that different paths have different policies that may not be consistent with each other. The system may resolve this inconsistency in the policies by combining existing policies to new policies that incorporate all rules and restrictions along the path and remove redundant polices.

In particular embodiments, after the local models have been trained for one or more iterations, the system may use graph learning to identify the best set of node models, parameters, and parameter groups for aggregating to the global model. Without the knowledge graph system, it could be very challenging to identify the best set of models because the best set of models may not be the latest version of node models. In particular embodiments, the system may select, based on the knowledge graph, a set of local models that have been trained on respective federated nodes and meets one or more pre-determined training criteria. The system may aggregate parameters of the set of local models to the global model.

In particular embodiments, knowledge graphs as structured knowledge data may be used in machine learning for feature information processing, feature engineering, and feature serving. In particular embodiments, the knowledge graph system may convert knowledge information across various entities into a knowledge graph and use graph learning to facilitate inference solutions to coordinate and optimize the federated learning process. In particular embodiments, graph neural networks (GNN) may extend convolutional neural networks (CNNs) with graph embedding and convolutions for solving non-Euclidean domain problems.

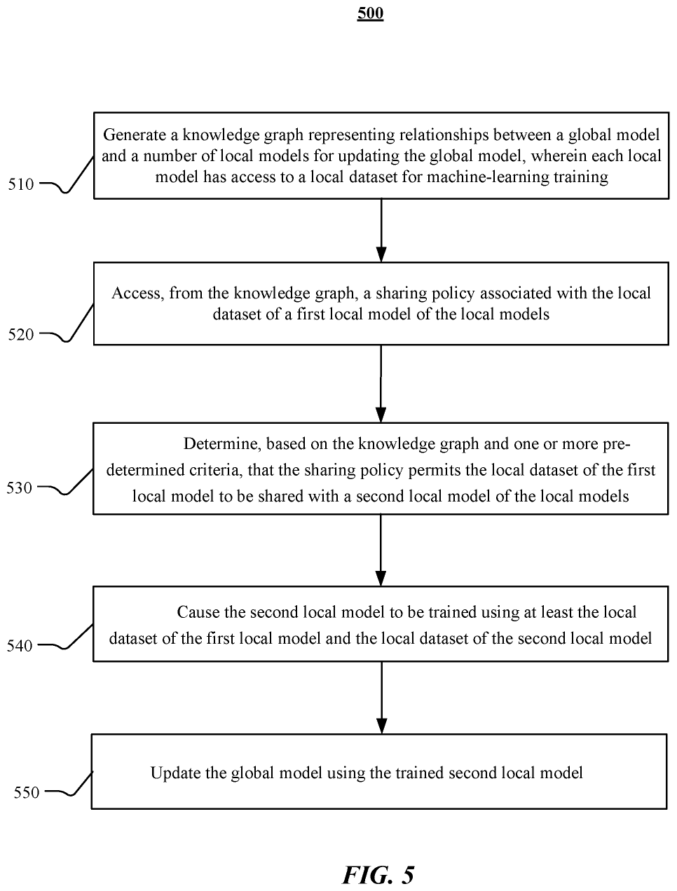

FIG. 5 illustrates an example method 500 of using a knowledge graph to optimize federated learning. The method may begin at step 510, where one or more computing systems of a number of computing systems may generate a knowledge graph representing relationships between a global model and a number of local models for updating the global model. Each local model may have access to a local dataset for machine-learning training. At step 520, the computing system(s) may access, from the knowledge graph, a sharing policy associated with the local dataset of a first local model of the local models. At step 530, the computing system(s) may determine, based on the knowledge graph and one or more pre-determined criteria, that the sharing policy permits the local dataset of the first local model to be shared with a second local model of the local models. At step 540, the computing system(s) may cause the second local model to be trained using at least the local dataset of the first local model and the local dataset of the second local model. At step 550, the computing system(s) may update the global model using the trained second local model.

In particular embodiments, the knowledge graph may include a number of nodes corresponding to a number of computing systems and a number of edges connecting these nodes. Each of the edges in the knowledge graph may represent a relationship between corresponding nodes connected by that edge. In particular embodiments, the local dataset of the first local model may be on a first computing system and the local dataset of the second local model may be on a second computing system. The computing system(s) may cause the local dataset of the first computing system to be shared by the first computing system and the second computing system. In particular embodiments, the computing system(s) may cause a partial local dataset of the first computing system to be shared by the first computing system and the second computing system according to the corresponding polices. The computing system(s) may update the knowledge graph by generating a new edge connecting a first node to a second node in the knowledge graph and assigning the sharing policy to the new edge. The first node may correspond to the first computing system hosting the first local model and the second node may correspond to the second computing system hosting the second local model.

In particular embodiments, the computing system(s) may determine a data sharing operation associated with the federated machine learning and to be performed by the one or more computing systems. The computing system(s) may register the data sharing operation associated with the federated machine-learning in the knowledge graph. In particular embodiments, the computing system(s) may determine, based on the knowledge graph, whether the data sharing operation is permitted by one or more sharing policies associated with the one or more computing systems. In response to the data sharing operation being permitted by the one or more sharing policies, the computing system(s) may allow the data sharing operation to be performed by the one or more computing systems. In response to the data sharing operation being prohibited by the one or more sharing policies, the computing system(s) may prevent the data sharing operation from being performed by the one or more computing systems.

In particular embodiments, the computing system(s) may determine an inferred sharing policy associated with a third dataset on the first computing system with respect to the second computing system. The computing system(s) may determine whether a data sharing operation for sharing the third dataset from the first computing system to the second computing system is permitted by the inferred sharing policy. In response to the data sharing operation being permitted by the inferred sharing policy, the computing systems may allow the data sharing operation to be performed to share the third dataset from the first computing system to the second computing system. In response to the data sharing operation being prohibited by the inferred sharing policy, the computing system(s) may prevent the third dataset from being shared from the first computing system to the second computing system.

In particular embodiments, the inferred sharing policy may be determined based on one or more existing sharing policies in the knowledge graph associated with an indirect path between the first computing system and the second computing system. The indirect path may be associated multiple edges of the knowledge graph. In particular embodiments, the computing system(s) may determine, based on the knowledge graph, one or more second computing systems of these computing systems storing a type of dataset that is needed to train a third local model. The computing system(s) may transmit the third local model to the one or more second computing systems of these computing systems. The third local model may be trained on the one or more second computing systems using that type of dataset.

In particular embodiments, the computing system(s) may determine, based on the knowledge graph, one or more new sharing policies associated with a first data sharing path based on at least one or more sharing policies associated with a second data sharing path. The computing system(s) may update the knowledge graph by assigning the one or more new sharing policies to the first data sharing path. In particular embodiments, the second data sharing path may be an alternative data sharing path to the first data sharing path and the first and second data sharing paths may each be associated with one or more edges of the knowledge graph. In particular embodiments, the computing system(s) may determine a lineage of a third dataset based on a data sharing path along which the third dataset has been shared. The computing systems may determine a data integrity metric or a data consistency metric based on the lineage of the third dataset. In particular embodiments, the computing system(s) may determine one or more inferred sharing policies for the third dataset based on the lineage of the third dataset.

In particular embodiments, the computing system(s) may select, based on the knowledge graph, a set of local models that have been trained on respective computing systems and meets one or more pre-determined training criteria from the plurality of local models and aggregate parameters of the set of local models to the global model. In particular embodiments, the knowledge graph may include one or more global sharing policies that are applicable to each of the computing systems or one or more local sharing policies that are applicable to a corresponding subset of computing systems of the computing systems. In particular embodiments, the computing systems may include a central server and a number of local computing systems connected to the central server through communication networks. The global model may be hosted on the central server and the local models may be hosted on respective local computing systems. In particular embodiments, the knowledge graph may be stored on the central server or one or more of the local computing systems. In particular embodiments, the knowledge graph may include a number of sub-graphs of different layers. Each sub-graph may be represented by a corresponding node in the knowledge graph and may be associated with a layer along a hierarchy.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for using a knowledge graph to optimize federated learning including the particular steps of the method of FIG. 5, this disclosure contemplates any suitable method for using a knowledge graph to optimize federated learning including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

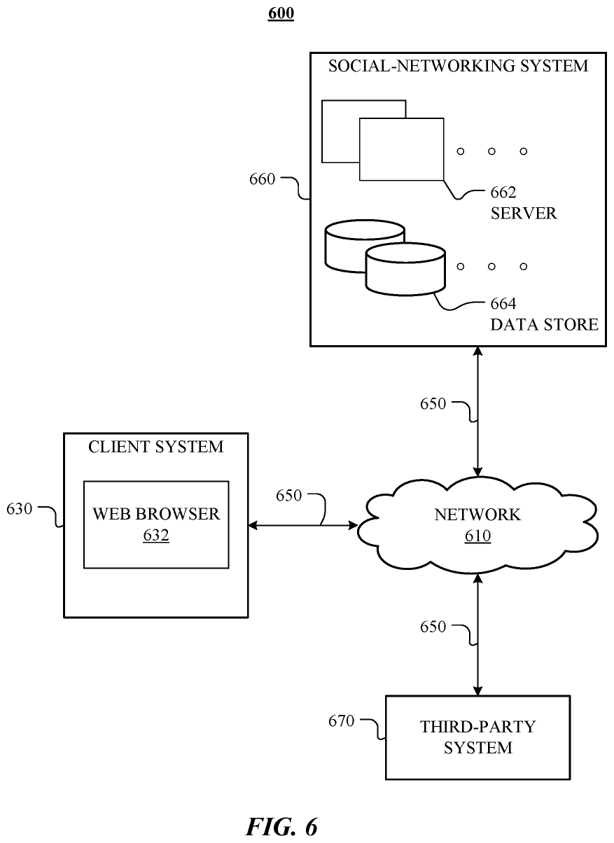

FIG. 6 illustrates an example network environment 600 associated with a social-networking system. Network environment 600 includes a client system 630, a social-networking system 660, and a third-party system 670 connected to each other by a network 610. Although FIG. 6 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 6 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular embodiments, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular embodiments, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular embodiments, client system 630 may include a web browser 632, and may have one or more add-ons, plug-ins, or other extensions. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 660 may be a network-addressable computing system that can host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular embodiments, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 662 may include hardware, software, or embedded logic components or a combination of two or more such components for carrying out the appropriate functionalities implemented or supported by server 662. In particular embodiments, social-networking system 660 may include one or more data stores 664. Data stores 664 may be used to store various types of information. In particular embodiments, the information stored in data stores 664 may be organized according to specific data structures. In particular embodiments, each data store 664 may be a relational, columnar, correlation, or other suitable database. Although this disclosure describes or illustrates particular types of databases, this disclosure contemplates any suitable types of databases. Particular embodiments may provide interfaces that enable a client system 630, a social-networking system 660, or a third-party system 670 to manage, retrieve, modify, add, or delete, the information stored in data store 664.

In particular embodiments, social-networking system 660 may store one or more social graphs in one or more data stores 664. In particular embodiments, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular embodiments, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular embodiments, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular embodiments, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular embodiments, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular embodiments, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular embodiments, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 660 also includes user-generated content objects, which may enhance a user's interactions with social-networking system 660. User-generated content may include anything a user can add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular embodiments, social-networking system 660 may include a variety of servers, sub-systems, programs, modules, logs, and data stores. In particular embodiments, social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular embodiments, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party systems 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user can be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

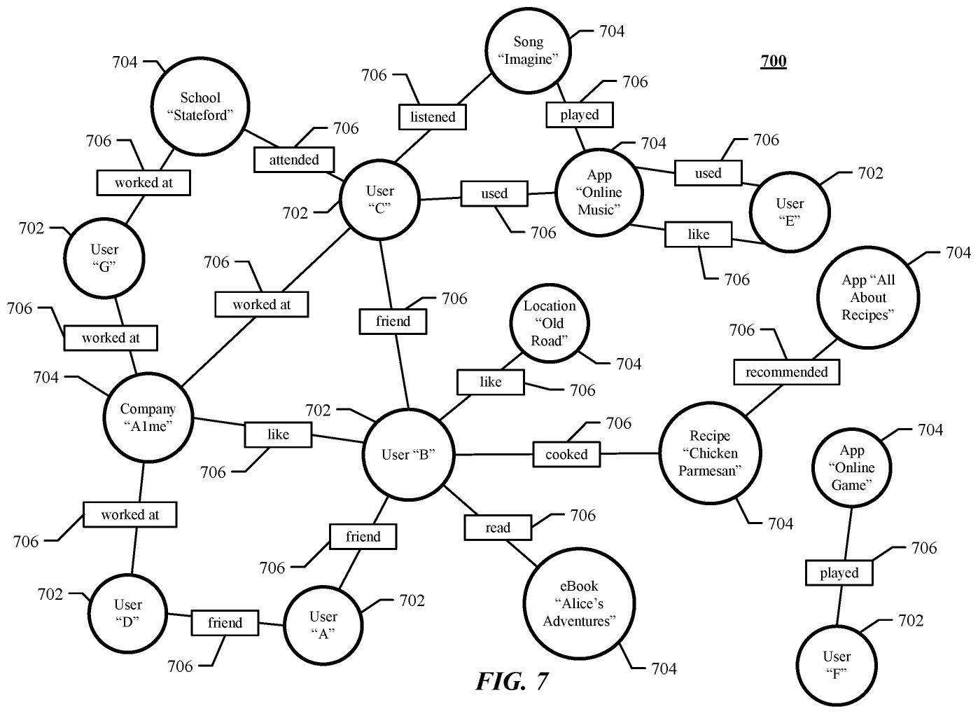

FIG. 7 illustrates example social graph 700. In particular embodiments, social-networking system 660 may store one or more social graphs 700 in one or more data stores. In particular embodiments, social graph 700 may include multiple nodes—which may include multiple user nodes 702 or multiple concept nodes 704—and multiple edges 706 connecting the nodes. Each node may be associated with a unique entity (i.e., user or concept), each of which may have a unique identifier (ID), such as a unique number or username. Example social graph 700 illustrated in FIG. 7 is shown, for didactic purposes, in a two-dimensional visual map representation. In particular embodiments, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular embodiments, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular embodiments, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular embodiments, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 660 or a third-party website associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “cat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or more of data stores 664. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “A1me” and the user node 702 of user “D,” and a third path passing through the user nodes 702 and concept nodes 704 representing school “Stateford,” user “G,” company “A1me,” and user “D.” User “C” and user “A” have a degree of separation of two because the shortest path connecting their corresponding nodes (i.e., the first path) includes two edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (a third-party online music application). In this case, social-networking system 660 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 660 may create a “played” edge 706 (as illustrated in FIG. 7) between concept nodes 704 corresponding to the song and the application to indicate that the particular song was played by the particular application. In this case, “played” edge 706 corresponds to an action performed by an external application (the third-party online music application) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “online music application”).

In particular embodiments, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular embodiments, social-networking system 660 may store an edge 706 in one or more data stores. In particular embodiments, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular embodiments, privacy settings may allow users to opt in or opt out of having their actions logged by social-networking system 660 or shared with other systems (e.g., third-party system 670). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may only be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

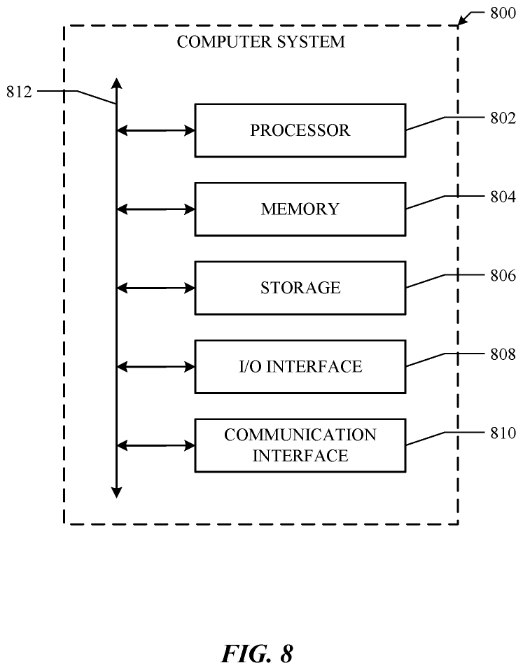

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform, without substantial spatial or temporal limitation, one or more steps of one or more methods described or illustrated herein. As an example and not by way of limitation, one or more computer systems 800 may perform, in real time or in batch mode, one or more steps of one or more methods described or illustrated herein. One or more computer systems 800 may perform, at different times or at different locations, one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method for federated machine learning, comprising, by one or more computing systems of a plurality of computing systems:
generating a knowledge graph representing relationships between a global model and a plurality of local models to update the global model, wherein the plurality of local models have access to a local dataset to facilitate machine-learning training, wherein the knowledge graph comprises a first graphic node corresponding to a first computing system hosting a first local model and a second graphic node corresponding to a second computing system hosting a second local model, and wherein the first local model and the second local model are trained in a previous training iteration excluding data exchange between the first computing system and the second computing system;
determining a similarity between the first computing system and the second computing system based on the previous training iteration, wherein the similarity indicates that a first local dataset on the first computing system meets a first criterion to train the second local model on the second computing system;
determining a new data sharing path between the first computing system and the second computing system based on a plurality of existing data sharing paths in the knowledge graph;
determining, based on data sharing policies associated with the plurality of existing data sharing paths in the knowledge graph, a data sharing policy associated with the new data sharing path;
determining, based on the knowledge graph and one or more pre-determined criteria, that the data sharing policy of the new data sharing path permits the first local dataset of the first computing system to be shared with the second computing system to facilitate training of the second local model by the first local dataset of the first local model associated with the first computing system;
transmitting, using one or more application programming interfaces, the first local dataset on the first computing system to the second computing system, wherein the second local model is trained using at least the first local dataset from the first computing system; and
updating the global model using the trained second local model.

2. The method of claim 1, wherein the knowledge graph comprises a plurality of nodes corresponding to the plurality of computing systems and a plurality of edges connecting the plurality of nodes, and wherein the plurality of edges represents a relationship between corresponding nodes connected by that edge.

3. The method of claim 1, further comprising:
updating the knowledge graph by generating a new edge connecting a first node to a second node in the knowledge graph and assigning the new sharing policy to the new edge, wherein the first node corresponds to the first computing system hosting the first local model and the second node corresponds to the second computing system hosting the second local model.

4. The method of claim 1, further comprising:
determining a data sharing operation associated with the federated machine learning and to be performed by the one or more computing systems; and
registering the data sharing operation associated with the federated machine learning in the knowledge graph, wherein the first local dataset on the first computing system is transmitted to the second computing system based on the data sharing operation.

5. (canceled)

6. The method of claim 1, further comprising:
determining an inferred sharing policy associated with a third dataset on the first computing system with respect to the second computing system.

7. The method of claim 6, further comprising:
determining whether a data sharing operation to share the third dataset from the first computing system to the second computing system is permitted by the inferred sharing policy;
in response to the data sharing operation being permitted by the inferred sharing policy, allowing the data sharing operation to be performed to share the third dataset from the first computing system to the second computing system; and
in response to the data sharing operation being prohibited by the inferred sharing policy, preventing the third dataset from being shared from the first computing system to the second computing system.

8. The method of claim 6, wherein the inferred sharing policy is determined based on one or more existing sharing policies in the knowledge graph associated with an indirect path between the first computing system and the second computing system, and wherein the indirect path is associated with multiple edges of the knowledge graph.

9. (canceled)

10. The method of claim 1, further comprising:
determining, based on the knowledge graph, one or more implied sharing policies associated with a first data sharing path based on at least one or more existing sharing policies associated with a second data sharing path; and
updating the knowledge graph by assigning the one or more implied sharing policies to the first data sharing path.

11. The method of claim 10, wherein the second data sharing path is an alternative data sharing path to the first data sharing path, and wherein the first data sharing path and the second data sharing path each is associated with one or more edges of the knowledge graph.

12. The method of claim 1, further comprising:
determining a lineage of a third dataset based on a third data sharing path used to share the third dataset; and
determining a data integrity metric or a data consistency metric based on the lineage of the third dataset.

13. The method of claim 1, further comprising:
determining one or more inferred sharing policies associated with the third dataset based on the lineage of the third dataset.

14. The method of claim 1, further comprising:
selecting, based on the knowledge graph, a set of local models that satisfy one or more pre-determined training criteria from the plurality of local models, wherein the set of local model comprises at least one local model trained during a training process; and
aggregating parameters of the set of local models to the global model.

15. The method of claim 1, wherein the knowledge graph comprises one or more global sharing policies that are applicable to the plurality of computing systems or one or more local sharing policies that are applicable to a corresponding subset of computing systems of the plurality of computing systems.

16. The method of claim 1, wherein the plurality of computing systems comprises a central server and a plurality of local computing systems connected to the central server through communication networks, and wherein the global model is on the central server and the plurality of local models are on respective local computing systems.

17. The method of claim 16, wherein the knowledge graph is stored on the central server or one or more of the plurality of local computing systems.

18. The method of claim 1, wherein the knowledge graph comprises a plurality of sub-graphs of different layers, and wherein the plurality of sub-graphs are represented by a corresponding node in the knowledge graph and is associated with a layer along a hierarchy.

19. One or more computer-readable non-transitory storage media comprising software that is operable when executed to:
generate a knowledge graph representing relationships between a global model and a plurality of local models to update the global model, wherein the plurality of local models have access to a local dataset to facilitate machine-learning training, wherein the knowledge graph comprises a first graphic node corresponding to a first computing system hosting a first local model and a second graphic node corresponding to a second computing system hosting a second local model, and wherein the first local model and the second local model are trained in a previous training iteration excluding data exchange between the first computing system and the second computing system;
determine a similarity between the first computing system and the second computing system based on the previous training iteration, wherein the similarity indicates that a first local dataset on the first computing system meets a first criterion to train the second local model on the second computing system;
determine a new data sharing path between the first computing system and the second computing system based on a plurality of existing data sharing paths in the knowledge graph;
determine, based on data sharing policies associated with the plurality of existing data sharing paths in the knowledge graph, a data sharing policy associated with the new data sharing path;
determine, based on the knowledge graph and one or more pre-determined criteria, that the data sharing policy of the new data sharing path permits the first local dataset of the first computing system to be shared with the second computing system to facilitate training of the second local model by the first local dataset of the first local model associated with the first computing system;
transmit, using one or more application programming interfaces, the first local dataset on the first computing system to the second computing system, wherein the second local model is trained using at least the first local dataset from the first computing system; and
update the global model using the trained second local model.

20. A system comprising:
one or more non-transitory computer-readable storage media comprising instructions; and
one or more processors coupled to the storage media and configured to execute the instructions to:
generate a knowledge graph representing relationships between a global model and a plurality of local models to update the global model, wherein the plurality of local models have access to a local dataset to facilitate machine-learning training, wherein the knowledge graph comprises a first graphic node corresponding to a first computing system hosting a first local model and a second graphic node corresponding to a second computing system hosting a second local model, and wherein the first local model and the second local model are trained in a previous training iteration excluding data exchange between the first computing system and the second computing system;
determine a similarity between the first computing system and the second computing system based on the previous training iteration, wherein the similarity indicates that a first local dataset on the first computing system meets a first criterion to train the second local model on the second computing system;
determine a new data sharing path between the first computing system and the second computing system based on a plurality of existing data sharing paths in the knowledge graph;
determine, based on data sharing policies associated with the plurality of existing data sharing paths in the knowledge graph, a data sharing policy associated with the new data sharing path;
determine, based on the knowledge graph and one or more pre-determined criteria, that the data sharing policy of the new data sharing path permits the first local dataset of the first computing system to be shared with the second computing system to facilitate training of the second local model by the first local dataset of the first local model associated with the first computing system;
transmit, using one or more application programming interfaces, the first local dataset on the first computing system to the second computing system, wherein the second local model is trained using at least the first local dataset from the first computing system; and
update the global model using the trained second local model.

21. The storage media of claim 19, wherein the instructions, when executed, further cause:
update of the knowledge graph by generating a new edge connecting a first node to a second node in the knowledge graph and assigning the new sharing policy to the new edge, wherein the first node corresponds to the first computing system hosting the first local model and the second node corresponds to the second computing system hosting the second local model.

22. The system of claim 20, wherein when the one or more processors execute the instructions, the system is configured to:
update the knowledge graph by generating a new edge connecting a first node to a second node in the knowledge graph and assigning the new sharing policy to the new edge, wherein the first node corresponds to the first computing system hosting the first local model and the second node corresponds to the second computing system hosting the second local model.
